(19) United States
(12) Patent Application Publication
(10) Pub. No.: US 2013/0162530 A1
(43) Pub. Date: Jun. 27, 2013

(54) CONTENT REPRODUCING DEVICE AND CONTENT REPRODUCING METHOD

(71) Applicant: Yosuke TAKAHASHI, Akishima-shi (JP)

(72) Inventor: Yosuke TAKAHASHI, Akishima-shi (JP)

(73) Assignee: KABUSHIKI KAISHA TOSHIBA, Tokyo (JP)

(21) Appl. No.: 13/609,020

(22) Filed: Sep. 10, 2012

(30) Foreign Application Priority Data
Dec. 27, 2011 (JP) 2011-287005

(51) Int. Cl. G06F 3/033

(52) U.S. Cl. 345/157

(57) ABSTRACT

According to one embodiment, a content reproducing device includes a content reproducing module, a gesture recognizing module and a reproduction position controller. The content reproducing module is configured to output a signal representing a content in which information to be displayed changes with time upon start of reproduction of the content. The gesture recognizing module is configured to recognize gesture information corresponding to operations. The reproduction position controller is configured to adjust a reproduction position of the content based on a first gesture and a second gesture comprising moving the first gesture.

### CROSS-REFERENCE TO RELATED APPLICATION(S)

This application is based upon and claims the benefit of priority from Japanese Patent Application No. 2011-287005, filed Dec. 27, 2011; the entire contents of which are incorporated herein by reference.

### BACKGROUND

1. Technical Field

One Embodiment relates to a content reproducing device which can be operated by gesture and a content reproducing method.

2. Description of the Related Art

A variety of software and devices which reproduce contents in which displayed information is changed with time have been proposed. Examples include a moving image player, a photo slideshow, digital signage, an RSS Ticker and the like. In many cases, these software and devices include an interface which changes displayed information after an operation, such as pausing or displaying of a related link, or newly displayed information in response to what is being displayed by the software or device at the time of the operation, and an operation interface which searches for a reproduction position desired by a user, such as fast-forwarding, rewinding, and a seek bar. Furthermore, a device having a touch-free function executes an operation corresponding to a hand shape or hand motion (hereinafter, collectively referred to as gesture) when the device recognizes the gesture while a user is instructing the operation without touching the device directly. For example, when the user opens his or her hand toward the device, the device executes a pausing operation.

### BRIEF DESCRIPTION OF THE DRAWINGS

FIG. 1 is an exemplary block diagram showing the configuration of a content reproducing device according to a first embodiment;

FIG. 2 is an exemplary sequence diagram in the content reproducing device according to the first embodiment;

FIG. 3 is an exemplary drawing for explaining a state before hand gesture is detected according to the first embodiment;

FIG. 4 is an exemplary drawing for explaining a state where hand gesture indicating pausing is detected according to the first embodiment;

FIG. 5 is an exemplary drawing for explaining a state under a seek operation according to the first embodiment;

FIG. 6 is an exemplary drawing for explaining a state where the hand gesture is ended according to the first embodiment; and

FIG. 7 is an exemplary sequence diagram in a case where an operation is executed when hand gesture is recognized according to a second embodiment.

### DETAILED DESCRIPTION

According to one embodiment, a content reproducing device includes a content reproducing module, a gesture recognizing module and a reproduction position controller. The content reproducing module is configured to output a signal representing a content in which information to be displayed changes with time upon start of reproduction of the content. The gesture recognizing module is configured to recognize gesture information corresponding to operations. The reproduction position controller is configured to adjust a reproduction position of the content based on a first gesture and a second gesture comprising moving the first gesture.

According to another one embodiment, a content reproducing device includes a content reproducing module, a gesture recognizing module, a reproduction position controller and an operation executing module. The content reproducing module is configured to output a signal representing a content in which information to be displayed changes with time upon start of reproduction of the content. The gesture recognizing module is configured to recognize a user's operation an execution result of which changes depending on information in the content being currently displayed. The reproduction position controller is configured to adjust a reproduction position where the user's operation is to be executed, in response to user's execution of a motion to move a user's hand while the user's hand is keeping a hand shape corresponding to a particular operation. The operation executing module is configured to execute the user's operation.

Hereinafter, various embodiments will be described hereinafter with reference to the accompanying drawings.

### First Embodiment

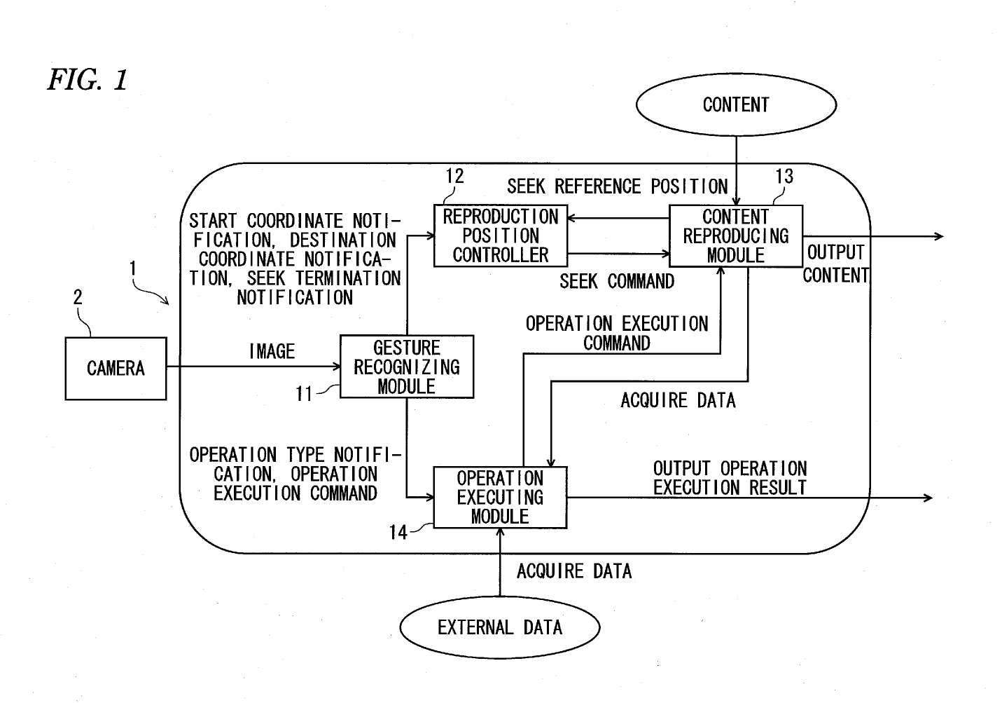

A first embodiment will be described with reference to FIGS. 1 to 6.

### <Background (Technical Base)>

A content reproducing device which will be hereinafter described with reference to the accompanying drawings is connected to a display device to output contents in which information to be displayed changes with time. Examples of the content reproducing device include a moving image player, a photo slideshow, a digital signage, an RSS Ticker and the like. For this device, one or more operations are prepared which result in different outcomes according to timings at which the one or more operations are executed. For example, the operations may include pausing and displaying of a related link. The pause operation pauses a screen at displayed information which is being output at a time when the pause operation is executed. The related link display operation displays a link related to information, which is displayed at a time when the related link display operation is executed, using a Web browser or the like. This content reproducing device executes these operations in a touch-free manner. Here, the term “touch-free” means a mechanism that recognizes user's hand shape and/or user's hand motion to control a device while the user does not directly touch the device. The content reproducing device uses a camera connected thereto to capture an image and analyzes the captured image to recognize hand shape and/or hand motion.

Here, in this embodiment, forming particular hand shape corresponding to an operation is defined as a hand gesture. Also, an action of moving a hand with the hand forming a particular hand shape is defined as move gesture. Further, these motions are defined together as gestures.

### <Device Configuration>

Next, the configuration of the content reproducing device will be described. FIG. 1 is an exemplary block diagram illustrating the configuration of the content reproducing device according to the first embodiment.

The content reproducing device 1 (hereinafter, may be simply referred to as a device) includes a gesture recognizing module 11, a reproduction position controller 12, a content reproducing module 13, an operation executing module 14, and the like. Also, a camera 2 is connected to the content reproducing device 1. The camera 2 is configured to capture video of an area in front of the device and to provide the latest screen shot of the video as an image in response to an acquisition request.

The gesture recognizing module 11 analyzes the image acquired from the camera to obtain hand gesture and coordinates at which the hand gesture is recognized. Any method may be used for recognition of the hand gesture. For example, a pattern matching method may be used which stores images of standard hand gestures in the device in advance and checks if the image acquired from the camera contains similar part to that of any of the images of the standard hand gestures.

The reproduction position controller 12 controls the content reproducing module 13 to perform a seek operation. The content reproducing module 13 has functions of reproducing contents and searching for a reproduction position desired by a user (fast-forwarding, rewinding, seek and the like).

The operation executing module 14 executes an operation received from the gesture recognizing module 11. If execution of the operation requires information, the operation executing module 14 may acquire such information from the content reproducing module 13 or the outside of the device 1. For example, when a related link is displayed, an operation of acquiring currently displayed information from the content reproducing module 13, calculating a related URL, acquiring a Web page corresponding to the related URL from an external Web server and displaying the acquired Web page is performed.

<Description on Operation with Reference to Sequence Diagram>

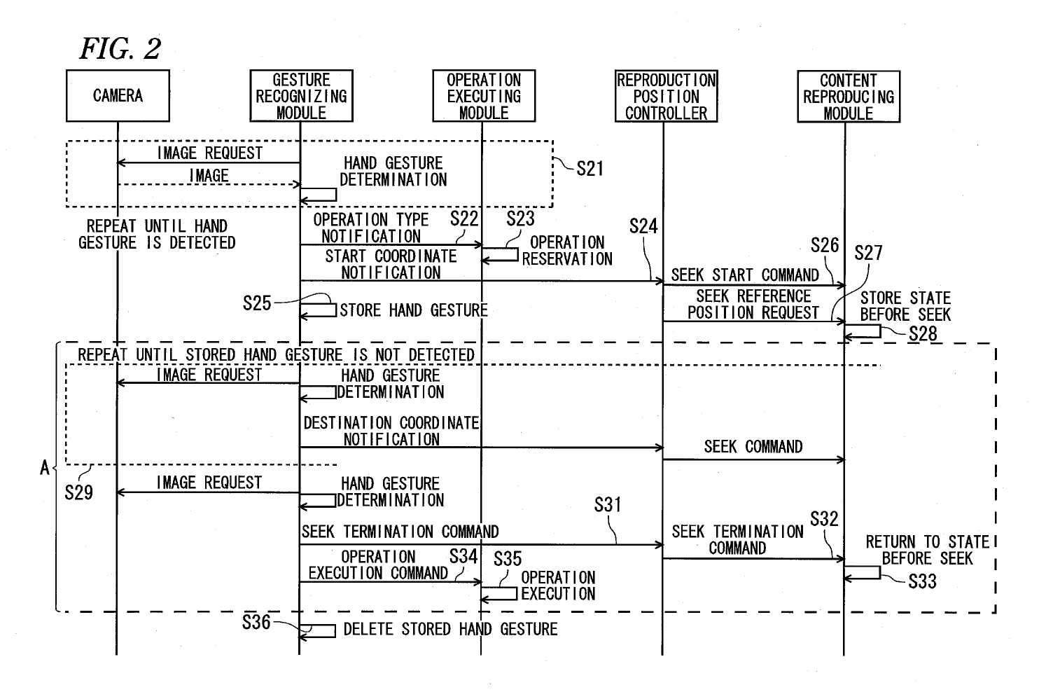

Next, an operation in the device 1 will be described with reference to a sequence diagram of FIG. 2.

### (In Case Where Hand Gesture is Not Detected)

The gesture recognizing module 11 periodically acquires images from the camera 2 at short time intervals to determine whether or not an acquired image contains hand gesture determination. In the hand gesture determination, the gesture recognizing module 11 determines as to whether or not hand gesture registered in the device 1 is contained in an acquired image. Until hand gesture is detected, the gesture recognizing module 11 repeats acquiring images and performing the hand gesture determination (step S21).

### (In Case Where Hand Gesture is Detected)

If the gesture recognizing module 11 detects hand gesture, the gesture recognizing module 11 notifies the operation executing module 14 of a type of an operation corresponding to the detected hand gesture (step S22). The operation executing module 14 reserves execution of the operation (step S23). Subsequently, the gesture recognizing module 11 notifies the reproduction position controller 12 of coordinates at which the hand gesture is detected as start coordinates (step S24). The detected coordinates may be expressed in such an x-y coordinate system in which the most upper left position in the image acquired from the camera is as an origin, for example. Here, the coordinates in which the hand gesture is detected are calculated as a point. However, any method may be used to calculate the coordinates. For example, such a method may be adopted where y coordinate of a center between the uppermost point and lowermost point of an area, which is determined as a hand, is set to y coordinate of the start coordinates and x coordinate of a center of the rightmost point and leftmost point of the area is set to x coordinate of the start coordinates. Further, the gesture recognizing module 11 stores the hand gesture detected at this time for determination of movement of the hand gesture (step S25). If the reproduction position controller 12 is notified the start coordinates, the reproduction position controller 12 notifies the content reproducing module 13 of seek start (step S26). Also, the reproduction position controller 12 acquires a reproduction position at that time from the content reproducing module 13, and then stores the acquired reproduction position as a seek reference position (step S27). When the seek operation is started, the content reproducing module 13 stores a reproduction state (under reproduction, under pause, under fast-forwarding or the like) before the start of the seek operation (step S28) and stops the content while keeping information at the current reproduction position being displayed.

### (In Case Where Hand Gesture is Moved)

When the gesture recognizing module 11 acquires an image from the camera 2 again, the gesture recognizing module 11 performs the hand gesture determination. If the detected hand gesture is the same as the hand gesture which has been stored, the detected coordinates are transmitted to the reproduction position controller 12 as destination coordinates. The reproduction position controller 12 performs the seek operation using the start coordinates, which were notified first, the destination coordinates, and the seek reference position (step S29). Here, the seek operation refers to an operation of changing the reproduction position to an instructed position and stopping the content in a state where information at the instructed position in the content is displayed. The reproduction position controller 12 instructs the content reproducing module 13 to calculate a corresponding amount of time based on a difference between the start coordinates and the destination coordinates and to change the reproduction position to a position which is far from the seek reference position by the calculated amount of time. Any method may be used as a method for calculating the amount of time for the change between the start coordinates and the destination coordinates. For example, a calculation method which calculates an amount of time so that movement of each one unit in the x direction corresponds to +0.01 seconds may be used. Further, it is not necessary to make the amount of time be proportional to the difference between the start coordinates and the destination coordinates. For example, destination coordinates may be stored every time, the latest destination coordinates may be compared with the immediately previous destination coordinates to calculate a movement speed of the hand gesture, and the movement speed of the hand gesture may be reflected in calculation of the amount of time. For example, a calculation method may be used in which even if the hand gesture moves the same distance, the amount of time changed in a case where the hand gesture moves faster is larger than that in a case where the hand gesture moves more slowly.

### (In Case Where Hand Gesture is Ended)

In the hand gesture determination, if hand gesture is not detected or if hand gesture which is different from the stored hand gesture is detected, the device 1 executes the operation which is reserved in the operation executing module 14. Firstly, the gesture recognizing module 11 transmits a seek termination notification to the reproduction position controller 12 (step S31). The reproduction position controller 12 transmits the seek termination notification to the content reproducing module 13 (step S32), and accordingly, the content reproducing module 13 returns to the stored reproducing state before the seek operation (step S33). Subsequently, the gesture recognizing module 11 transmits an operation execution command to the operation executing module 14 (step S34), and accordingly, the operation executing module 14 performs the reserved operation (step S35). If any data is required in this execution, metadata may be acquired from the content reproducing module 13 or external data may be acquired. Thereafter, the operation is performed, and then, pausing or displaying of the related link is performed. The hand gesture stored in the gesture recognizing module 11 is deleted (step S36). If hand gesture which is different from the stored hand gesture is detected, the process to be performed in the case where hand gesture is detected is subsequently performed.

### <Example of User Interface>

An example of a user interface of the device 1 will be described with reference to the accompanying drawings. Here, a case where pausing is performed in a reproduction position where a vehicle is located at the center of a screen when a user is watching a moving image content in which the vehicle travels from left to right on the screen will be described as an example.

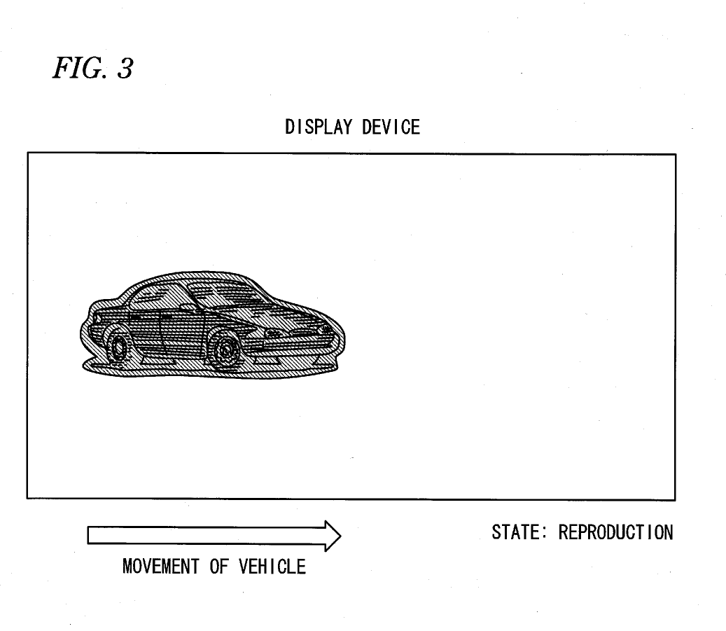

FIG. 3 is an exemplary diagram illustrating a state where an output of a reproduction result of the moving image content is displayed on a display device in this device 1. It is assumed that the camera 2 is provided toward in the same direction as a direction to which the display device is directed. Further, it is assumed that the device 1 is in a reproduction state. The content may be any of a variety of contents provided through a cable TV, Blu-ray (registered trademark) or the like.

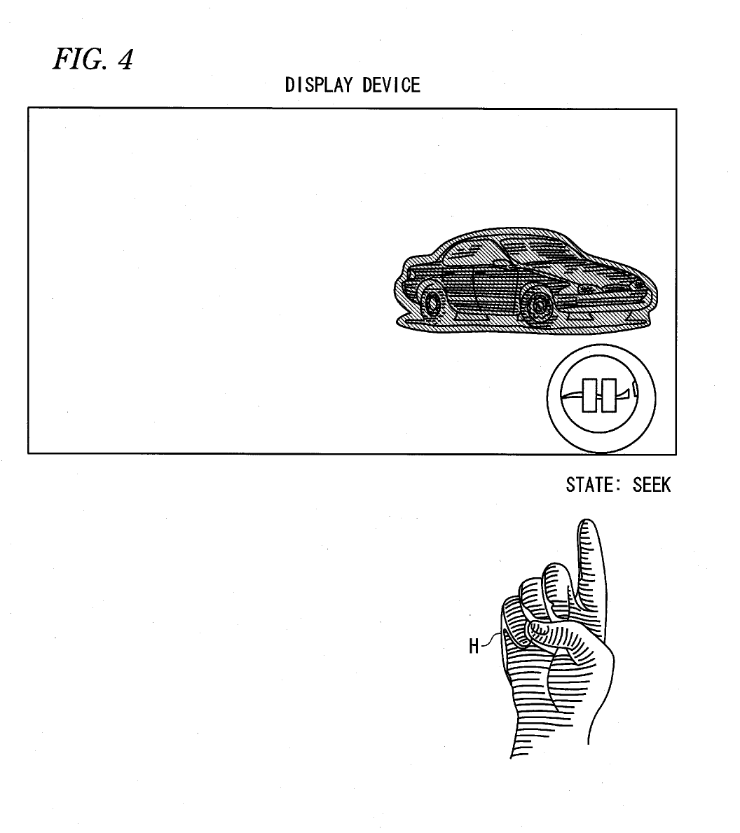

FIG. 4 is an exemplary diagram illustrating a state which happens after the state shown in FIG. 3 and which is at a time point when hand gesture indicating pausing is recognized after the moving image content has passed through a reproduction position at which a user wanted to pause the moving image content. A hand H in a lower part of FIG. 4 shows that the user performs the hand gesture indicating pausing. When the camera 2 of this device 1 captures the hand gesture of the user and the gesture recognizing module 11 in the device 1 detects the hand gesture indicating pausing, the seek operation is started. In the seek operation, the screen is brought in a stationary state. As shown in the example of FIG. 4, an icon corresponding to the recognized hand gesture may be displayed on the screen so that the user can confirm whether or not the hand gesture is correctly recognized.

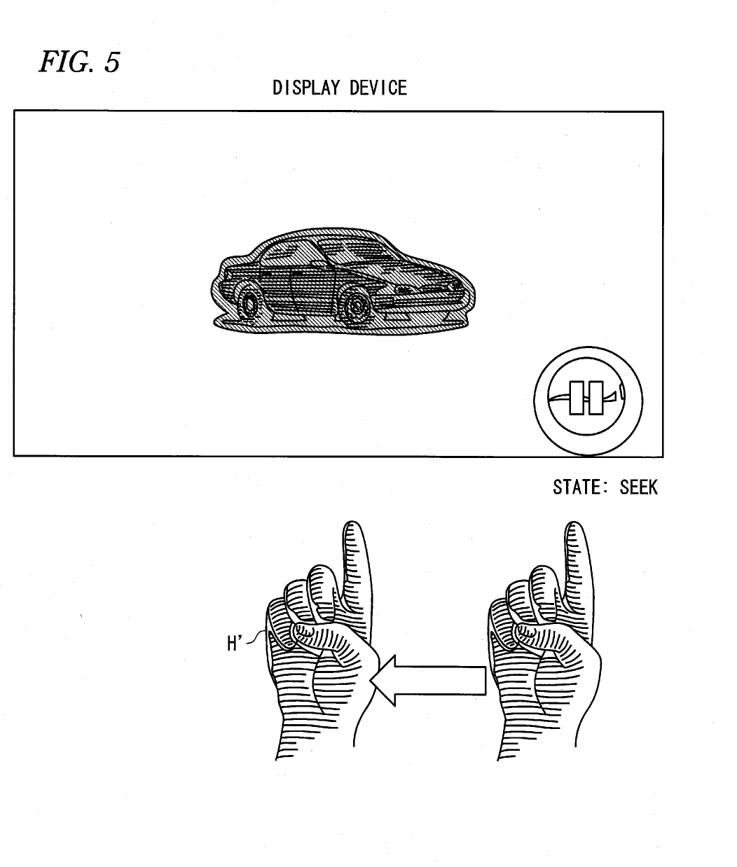

FIG. 5 is an exemplary diagram illustrating a state where move gesture is performed while the hand gesture performed in FIG. 4 is being kept. In the example shown in FIG. 5, by moving the hand to the left (to H′) while the hand gesture is being kept, the reproduction position is rewound by a corresponding amount. Since the seek operation state is kept during the movement of the hand, the reproduction position is changed according to the move gesture, and the moving image content is brought in a stationary state at the changed reproduction position.

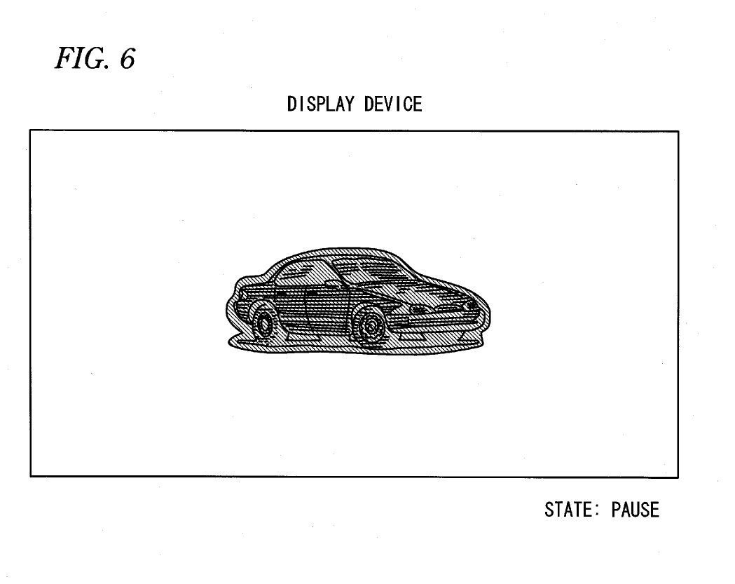

FIG. 6 is an exemplary diagram illustrating a state where the user terminates the hand gesture at a time point when the seek operation has been performed to the desired reproduction position by performing the move gesture shown in FIG. 5. If hand gesture is not detected, the gesture recognizing module 11 instructs the operation executing module 14 to execute the operation. In this example, pausing is executed.

### Second Embodiment

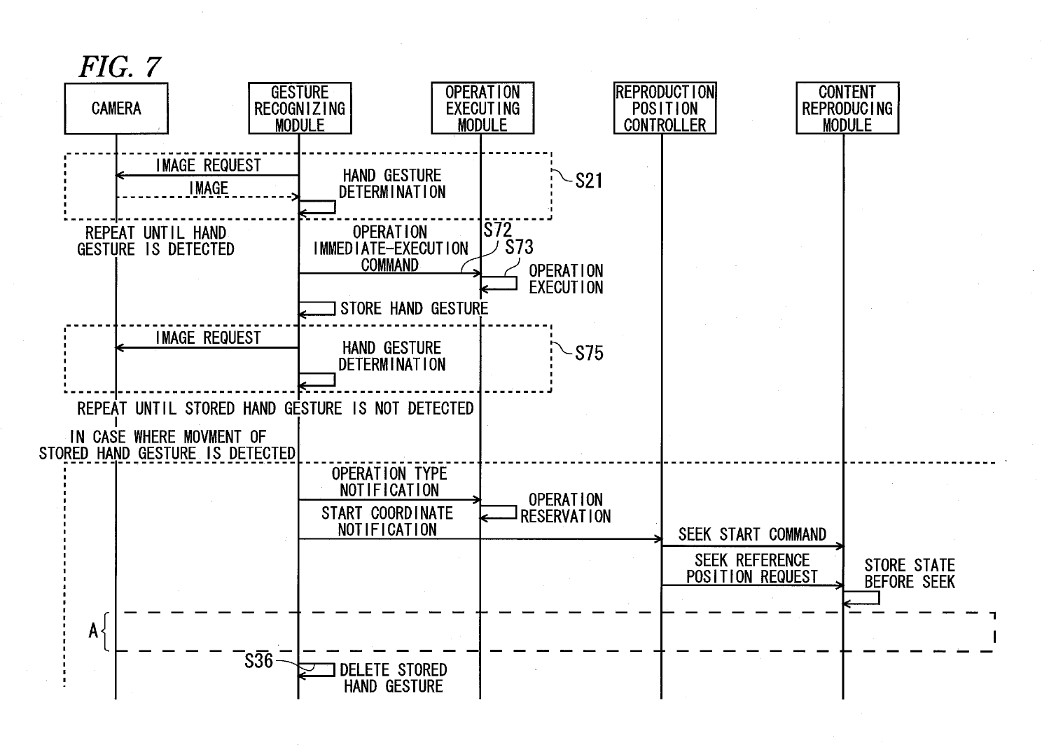

A second embodiment will be described with reference to FIG. 7. Descriptions on parts, units, modules and devices similar to those of the first embodiment will be omitted.

In the first embodiment, the process is not executed at a time point when the hand gesture is recognized, but the process is executed when the hand gesture is ended. If a user wants to execute an operation without adjustment of the reproduction position, it takes extra time to recognize end of the hand gesture. However, for example, after pausing is executed once when the hand gesture is recognized, the reproduction position may be changed and then pausing may be executed again. Even in displaying of a related link, displaying of the related link at a time when the hand gesture is recognized may be stopped once, and then the related link may be displayed again.

Then, FIG. 7 is an exemplary sequence diagram illustrating a case where an operation is executed even at a time when hand gesture is recognized. The second embodiment is different from the first embodiment in that when hand gesture is detected (step S21), the gesture recognizing module 11 transmits an operation immediate-execution command to the operation executing module 14 (step S72), and that the operation executing module 14 receives the operation immediate-execution command and executes an operation immediately (step S73). The operation immediate-execution command includes information about a type of the operation. Here, the screen is not in a stationary state. Then, the procedure proceeds to a state where the stored hand gesture is detected (step S75). Only after movement of the stored hand gesture is detected, the gesture recognizing module 11 performs an operation type notification and a start coordinate notification to come into the seek operation state. Then, procedures similar to those of the first embodiment are performed (see the procedures pointed by the symbol “A” in FIG. 2). If the stored hand gesture becomes not detected without movement of the stored hand gesture being detected, the stored hand gesture is deleted and the device 1 returns to the initial state.

When a user wants to perform an operation such pausing or displaying a related link at a certain position in a content, the operation may not be executed at the desired position because of delay of the user's operation or delay of the recognition process of the device. At this time, the user once adjusts a reproduction position by fast-forwarding, rewinding or seek, and then executes the desired operation. Processes from a time when the user starts gesture to a time when the user ends the gesture will be described.

Firstly, it is assumed that a fast-forwarding or rewinding operation is used. It is further assumed that one hand gesture is assigned to each of the fast-forwarding operation and the rewinding operation. In this case, the following four operations are performed.

1. Hand gesture corresponding to a desired operation (which is recognized in a delayed fashion)

2. Fast-forwarding hand gesture and/or rewinding hand gesture

3. The hand gesture corresponding to the desired operation

4. End of gesture

Next, it is assumed that hand gesture corresponding to the seek operation is used. Since the seek operation involves gesture of continuously changing the reproduction position, it is generally assumed that the seek operation is performed by hand gesture which starts the seek operation and move gesture which moves a hand horizontally (alternatively, vertically, forward and backward, or circularly).

1. Hand gesture of a desired operation (which is recognized in a delayed fashion)

2. Hand gesture corresponding to start of the seek operation

3. Move gesture corresponding to the seek operation (for moving the reproduction position)

4. The hand gesture corresponding to the desired operation (if the desired operation is pausing or reproducing, the seek function may make this process necessary)

5. End of gesture

Finally, the case where the user interface according to the second embodiment is used will be described.

1. Hand gesture corresponding to a desired operation (which is recognized in a delayed fashion)

2. Move gesture corresponding to adjusting a reproduction position

3. End of gesture

That is, when a desired operation cannot be executed in a desired reproduction position and the reproduction position is adjusted again for execution of the desired operation, the user interface according to the second embodiment minimizes the user's motion. On the other hand, if it is not necessary to adjust the reproduction position, any method includes the following processes.

1. Hand gesture corresponding to a desired operation

2. End of gesture

Thus, when adjustment is not necessary, the user interface according to the second embodiment does not require the user to perform an unnecessary operation. Thus, the user interface according to the second embodiment can reduce the burden of the user when the user is watching a content. Thus, the user can watch the content more comfortably.

According to the user interface according to the above-described embodiments, a type of an operation is determined based on gesture of a hand shape, a reproduction position where the operation is executed is determined based on gesture of moving a hand, and the operation is then executed upon end of the gesture.

When the user wants to perform the operation, such as pausing or displaying of a related link, at a certain position in a content, the operation may not be executed in the desired position because of delay of the user's operation or delay of the recognition process of the device. At this time, the user adjusts the reproduction position once using a fast-forwarding operation, a rewinding operation and/or a seek bar operation, and then, executes the desired operation. Here, compared with a method in which gesture for adjusting the reproduction position and gesture corresponding to the desired operation are performed one by one, the user interface according to the embodiments can adjust the reproduction position only by moving the hand at a time point when the user confirms that the recognition of the gesture is delayed, and it is not necessary to perform the gesture corresponding to the desired operation again. This leads to reduction in the burden of the user, and the user can enjoy the content comfortably.

### (Complementary Description About Embodiments)

(1) A device can display a content in which information to be displayed changes with time upon start of reproduction of the content, execute an operation an execution result of which changes depending on information in the content being currently displayed, adjust a reproduction position where the operation is to be executed in response to user's execution of a motion to move a user's hand while the user's hand is keeping a hand shape corresponding to a particular operation, and execute the operation upon end of the motion.
(2) A device can display a content in which information to be displayed changes with time upon start of reproduction of the content, can execute an operation an execution result of which changes depending on information in the content being currently displayed, enables a user to execute a desired job in response to a user's hand shape corresponding to a particular operation, can adjust a reproduction position where the operation is to be executed in response to a motion to move a user's hand as it is, and can execute the operation again upon end of the motion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. Furthermore, elements of different embodiments may be combined appropriately. The accompanying claims and their equivalents are intended to cover such forms or modifications as would fall within the scope and spirit of the inventions.

What is claimed is:

1. A content reproducing device comprising:
a content reproducing module configured to output a signal representing a content in which information to be displayed changes with time upon start of reproduction of the content;
a gesture recognizing module configured to recognize gesture information corresponding to operations; and
a reproduction position controller configured to adjust a reproduction position of the content based on a first gesture and a second gesture comprising moving the first gesture.

2. The content reproducing device of claim 1, wherein upon end of the second gesture, an operation executing module executes an operation based on the first gesture.

3. The content reproducing device of claim 1, wherein
upon start of the second gesture an operation executing module executes an operation based on the first gesture, and
after the second gesture is ended, the operation executing module comes into a state where the operation executing module is ready to execute another operation based on another gesture following the second gesture.

4. The content reproducing device of claim 1, wherein the operation includes a seek operation.

5. A content reproducing method comprising:
outputting a signal representing a content in which information to be displayed changes with time upon start of reproduction of the content;
recognizing a first gesture corresponding to a first operation and a second gesture corresponding to a second operation; and
adjusting a reproduction position of the content based on a first gesture and a second gesture comprising moving the first gesture.
